(19) United States
(12) Patent Application Publication
(10) Pub. No.: US 2020/0244017 A1
(43) Pub. Date: Jul. 30, 2020

(54) COAXIAL CABLE CONNECTOR

(71) Applicant: TCC RFTECH Co., Ltd., NEW TAIPEI CITY (TW)

(72) Inventor: Po-Yi Chen, New Taipei City (TW)

(21) Appl. No.: 16/746,946

(22) Filed: Jan. 19, 2020

(30) Foreign Application Priority Data
Jan. 30, 2019 (TW) 108103481
Nov. 21, 2019 (TW) 108142329

(51) Int. Cl. H01R 24/40; H01R 9/05; H01R 13/66

(52) U.S. Cl. CPC H01R 24/40; H01R 2103/00; H01R 13/6691; H01R 9/0518

(57) ABSTRACT

A coaxial cable connector detachably jackets a coaxial cable. The coaxial cable connector includes a metal sleeve, a clamping sleeve, a coupling sleeve, and an internal conductive ring. The clamping sleeve is connected to a first end portion of a main body of the metal sleeve for being squeezed to deform radially to tightly clamp the coaxial cable. The coupling sleeve is disposed at a second end portion of the main body. The internal conductive ring is disposed in a ring containing space of the main body. When the main body jackets the coaxial cable, the metal sleeve is in contact with an external surface of a metal layer of the coaxial cable via the internal conductive ring but not in contact with an internal surface of the metal layer to establish electrical connection between the metal sleeve and the metal layer.

### BACKGROUND OF THE INVENTION

### 1. Field of the Invention

The present invention relates to a coaxial cable connector, and more specifically, to a coaxial cable connector for solving the cable aging problem.

### 2. Description of the Prior Art

In general, a coaxial cable is mainly assembled with a coaxial cable to be electrically connected to two electronic apparatuses for establishing signal transmission (e.g. radio frequency signal transmission) between the two electronic apparatuses. The radio frequency signal having a high frequency is highly sensitive to external noise having a different frequency, so that the transmission quality of the radio frequency signal is easily influenced by the external noise. Thus, the EMI (Electromagnetic Interference) shielding design is much important to connection of the coaxial cable and the coaxial cable connector when the coaxial cable is utilized to transmit radio frequency signal having a high frequency.

The EMI shielding design usually involves utilizing a metal body to completely seal a space for isolating electromagnetic signals in the space from electromagnetic signals outside the space, so as to generate the EMI shielding effect. For example, in the prior art, as shown in FIG. 1 and FIG. 2, a coaxial cable assembly 1 includes a coaxial cable 2 and a coaxial cable connector 3. An insulation layer 12, a metal foil layer 14, a metal braid layer 16 and a protection layer 18 cover a central conductor 10 sequentially to form the coaxial cable 2. The metal foil layer 14 and the metal braid layer 16 can provide EMI and RFI (Radio Frequency Interference) shielding when radio signals are transmitted via the coaxial cable 2. The coaxial cable connector 3 includes a metal sleeve 20, a coupling sleeve 22, and a clamping sleeve 24. The metal sleeve 20 has a splitting sleeve 26 and a main body 28. The clamping sleeve 24 includes an internal sleeve 30 and an external sleeve 32.

After the coaxial cable 2 is inserted into the coaxial cable connector 3, an auxiliary tool is utilized to push the external sleeve 32 axially toward the internal sleeve 30 for squeezing the internal sleeve 30. During this process, radial deformation of the internal sleeve 30 occurs to make the internal sleeve 30 clamp the metal braid layer 16 and the protection layer 18 (as shown in FIG. 2). Via an elastic bias force provided by the protection layer 18, the metal braid layer 16 could be in contact with the splitting sleeve 26 steadily, so as to establish electrical connection between the metal braid layer 16 of the coaxial cable 2 and the coaxial cable connector for generating the EMI shielding effect and improving the performance of the coaxial cable connector 3 in insertion loss and reflection loss.

However, since gradual embrittlement of plastic material occurs due to the environmental influence (e.g. temperature or moisture) over a period of time, it causes a decline of an elastic bias force generated by the protection layer, so as to influence electrical connection between the metal braid layer of the coaxial cable and the coaxial cable connector. Thus, the performance of the coaxial cable connector in EMI and RFI shielding, insertion loss, and reflection loss is reduced gradually.

### SUMMARY OF THE INVENTION

The present invention provides a coaxial cable connector detachably jacketing a coaxial cable. The coaxial cable connector includes a metal sleeve, a clamping sleeve, a coupling sleeve, and an internal conductive ring. The metal sleeve has a main body. A ring containing space is formed in the main body. The clamping sleeve is connected to a first end portion of the main body for being squeezed to deform radially to clamp the coaxial cable tightly. The coupling sleeve is disposed at a second end portion of the main body. The internal conductive ring is disposed in the ring containing space. When the main body jackets the coaxial cable, the metal sleeve is in contact with an external surface of a metal layer of the coaxial cable via the internal conductive ring but not in contact with an internal surface of the metal layer, so as to establish electrical connection between the metal sleeve and the metal layer.

The present invention further provides a coaxial cable connector detachably jacketing a coaxial cable. The coaxial cable connector includes a metal sleeve, a coupling sleeve, an external conductive ring, and a clamping sleeve. The metal sleeve has a splitting sleeve and a main body. The splitting sleeve extends axially from a first end portion of the main body. The splitting sleeve penetrates between an insulation layer of the coaxial cable and a metal braid layer of the coaxial cable when the coaxial cable connector jackets the coaxial cable, so as to make the main body jacket the insulation layer and make the metal braid layer jacket the splitting sleeve. The coupling sleeve is disposed at a second end portion of the main body. The external conductive ring jackets the splitting sleeve. The external conductive ring is in contact with the splitting sleeve to establish electrical connection between the metal sleeve and the metal braid layer when the splitting sleeve penetrates between the insulation layer and the metal braid layer. The clamping sleeve jackets the first end portion of the main body. The clamping sleeve is squeezed to deform radially to clamp the coaxial cable tightly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an axial cross-sectional diagram of a coaxial cable according to the prior art.

FIG. 2 is an axial cross-sectional diagram of a coaxial cable assembly according to the prior art.

FIG. 3 is an axial cross-sectional diagram of a coaxial cable and a coaxial cable connector according to an embodiment of the present invention.

FIG. 4 is an exploded diagram of the coaxial cable and the coaxial cable connector in FIG. 3.

FIG. 5 is an enlarged diagram of an external conductive ring in FIG. 4 from another viewing angle.

FIG. 6 is an enlarged diagram of an internal conductive ring in FIG. 4 from another viewing angle.

FIG. 7 is a cross-sectional diagram of the coaxial cable in FIG. 3 being fixed to the coaxial cable connector.

FIG. 8 is an axial cross-sectional diagram of the coaxial cable and a coaxial cable connector according to another embodiment of the present invention.

FIG. 9 is an exploded diagram of the coaxial cable and the coaxial cable connector in FIG. 8.

FIG. 10 is a cross-sectional diagram of the coaxial cable in FIG. 8 being fixed to the coaxial cable connector.

FIG. 11 is an axial cross-sectional diagram of a coaxial cable and a coaxial cable connector according to another embodiment of the present invention.

FIG. 12 is a cross-sectional diagram of the coaxial cable in FIG. 11 being fixed to the coaxial cable connector.

FIG. 13 is a partial enlarged diagram of a metal sleeve in FIG. 12.

FIG. 14 is an axial cross-sectional diagram of a coaxial cable connector according to another embodiment of the present invention.

FIG. 15 is a cross-sectional diagram of the coaxial cable connector in FIG. 14 being fixed to the coaxial cable.

FIG. 16 is an axial cross-sectional diagram of a coaxial cable connector according to another embodiment of the present invention.

FIG. 17 is an exploded diagram of a coaxial cable connector according to another embodiment of the present invention.

FIG. 18 is an axial cross-sectional diagram of the coaxial cable connector in FIG. 17.

FIG. 19 is a cross-sectional diagram of the coaxial cable connector in FIG. 18 being fixed to the coaxial cable.

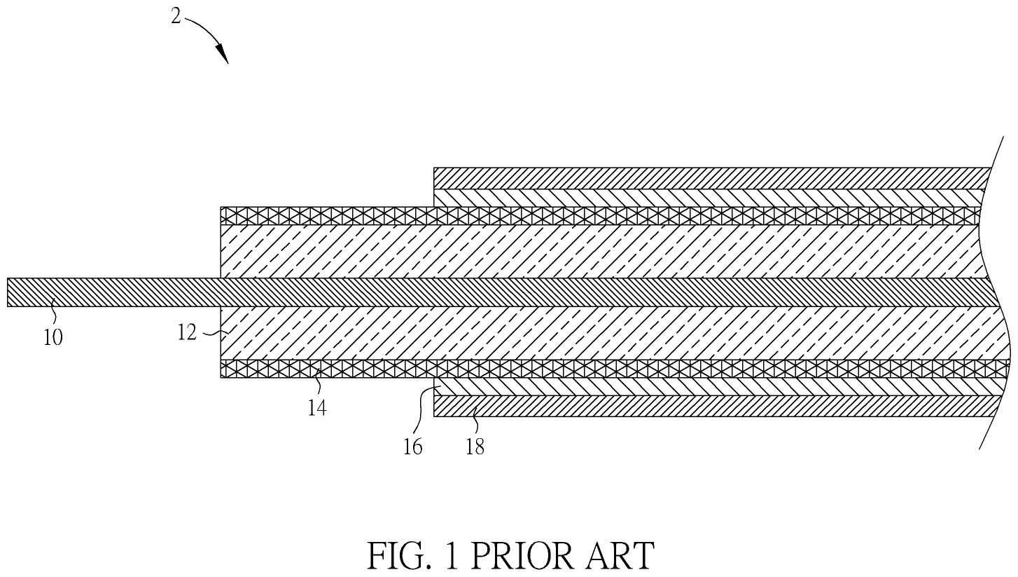

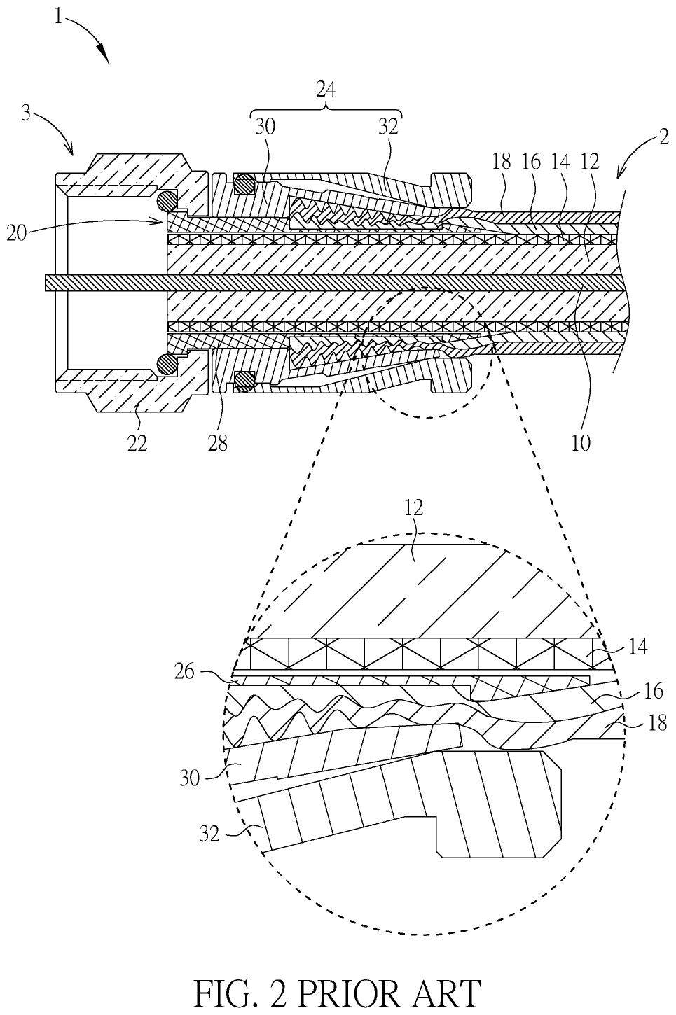

### DETAILED DESCRIPTION

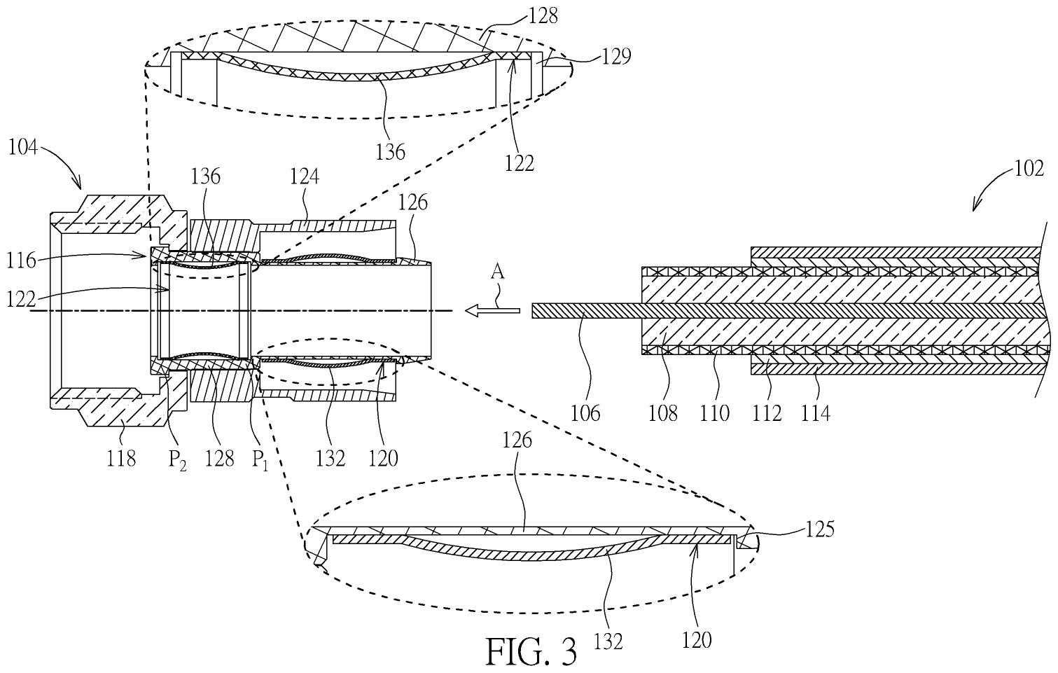

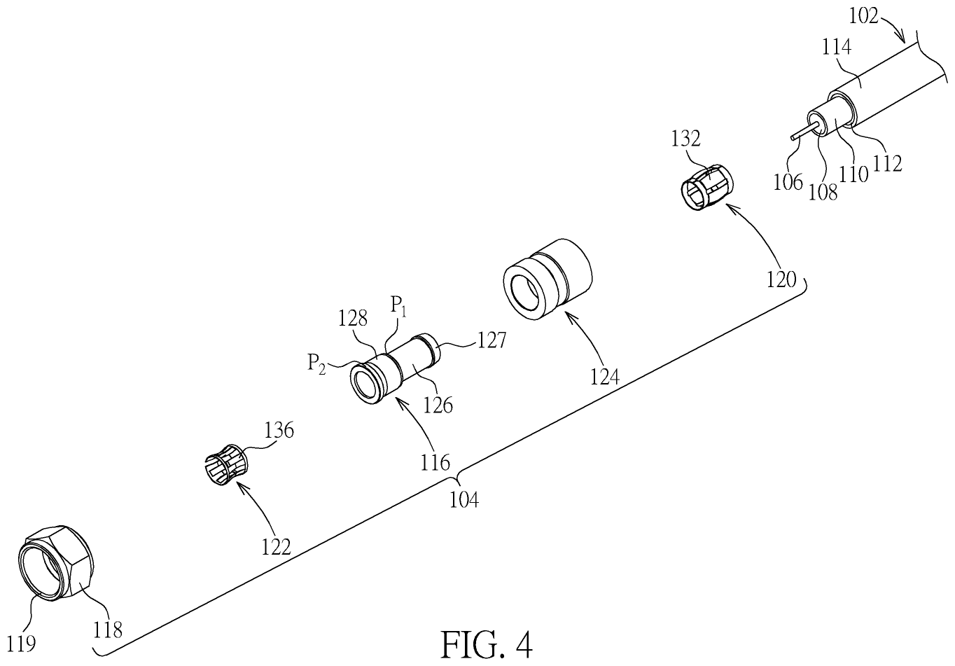

Please refer to FIG. 3 and FIG. 4. FIG. 3 is an axial cross-sectional diagram of a coaxial cable 102 and a coaxial cable connector 104 according to an embodiment of the present invention. FIG. 4 is an exploded diagram of the coaxial cable 102 and the coaxial cable connector 104 in FIG. 3. As shown in FIG. 3 and FIG. 4, the coaxial cable 102 includes a central conductor 106, an insulation layer 108, a metal foil layer 110, a metal braid layer 112, and a protection layer 114 (preferably made of plastic material, but not limited thereto). In this embodiment, combination of the metal foil layer 110 and the metal braid layer 112 can be regarded as a metal layer of the coaxial cable 102 for providing EMI and RFI shielding when radio frequency signals are transmitted via the coaxial cable 102. The coaxial cable connector 104 is detachably connected to the coaxial cable 102 and includes a metal sleeve 116, a coupling sleeve 118, an external conductive ring 120, an internal conductive ring 122, and a clamping sleeve 124.

As shown in FIG. 3, the insulation layer 108, the metal foil layer 110, the metal braid layer 112, and the protection layer 114 cover the central conductor 106 sequentially to cooperatively form the coaxial cable 102. As for the related description for the covering layer design of the coaxial cable 102, it is commonly seen in the prior art and omitted herein.

As shown in FIG. 3 and FIG. 4, the metal sleeve 116 has a splitting sleeve 126 and a main body 128, the clamping sleeve 124 jackets a first end portion P₁ of the main body 128, and the splitting sleeve 126 extends axially from the first end portion P₁ of the main body 128. Accordingly, when the coaxial cable connector 104 jackets the coaxial cable 102, the splitting sleeve 126 penetrates between the metal foil layer 110 and the metal braid layer 112 to make the main body 128 jacket the metal foil layer 110 and make the metal braid layer 112 jacket the splitting sleeve 126. In this embodiment, a front inclined-surface end could be preferably formed on the splitting sleeve 126 for guiding the splitting sleeve 126 to penetrate between the metal foil layer 110 and the metal braid layer 112 more smoothly. The coupling sleeve 118 is disposed at a second end portion P₂ of the main body 128. In practical application, the coupling sleeve 118 could be preferably a hexagonal-shaped nut structure and have an internal thread structure 119 (but not limited thereto). As such, the coaxial cable connector 104 can be coupled to an electronic apparatus capable of receiving coaxial cable signals, such as a digital TV set-top box or a cable modem, via the coupling sleeve 118 in a screw-locking manner.

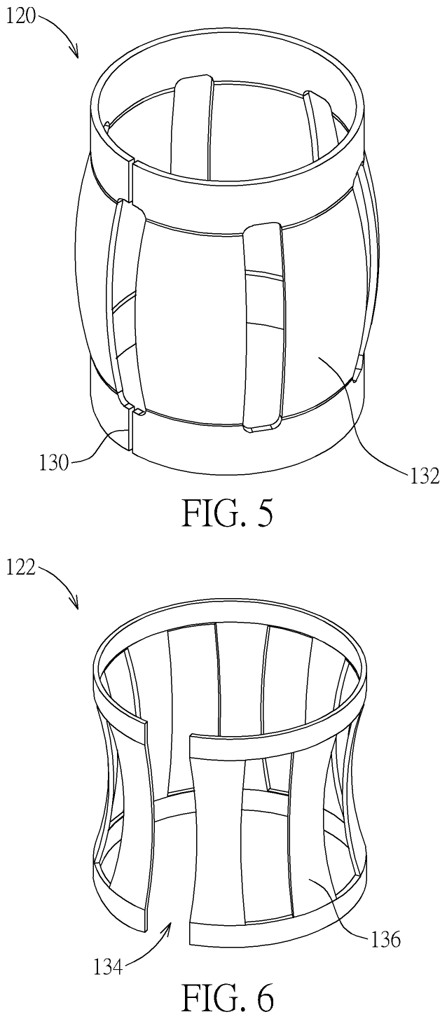

Please refer to FIG. 3, FIG. 4, FIG. 5, and FIG. 6. FIG. 5 is an enlarged diagram of the external conductive ring 120 in FIG. 4 from another viewing angle. FIG. 6 is an enlarged diagram of the internal conductive ring 122 in FIG. 4 from another viewing angle. As shown in FIG. 3, FIG. 4, FIG. 5, and FIG. 6, the external conductive ring 120 jackets the splitting sleeve 126, and the internal conductive ring 122 is disposed in the main body 128. A ring containing space 125 could be preferably formed on the splitting sleeve 126 for containing and axially limiting the external conductive ring 120, so as to prevent detachment of the external conductive ring 120 from the splitting sleeve 126. A ring containing space 129 could be preferably formed on the main body 128 for containing and axially limiting the internal conductive ring 122, so as to prevent detachment of the internal conductive ring 122 from the main body 128.

To be more specific, in this embodiment, a cut-off slot 130 could be preferably formed on the external conductive ring 120 (but not limited thereto) to make the external conductive ring 120 C-shaped and deformable radially, so that the external conductive ring 120 could jacket the splitting sleeve 126 elastically. A plurality of arc-shaped strips 132 could be formed on the external conductive ring 120 in a radial arrangement and bends outwardly relative to the external conductive ring 120. The amount of the strip and the curvature of each strip on the external conductive ring 120 could be varied according to the practical application of the coaxial cable connector 104 and could be not limited to FIG. 5. Accordingly, the external conductive ring 120 can have preferable radial elasticity to ensure that the external conductive ring 120 can be surely in contact with the splitting sleeve 126 and the metal braid layer 112 when the coaxial cable connector 104 jackets the coaxial cable 102.

Similarly, in this embodiment, a cut-off slot 134 could be preferably formed on the internal conductive ring 122 (but not limited thereto) to make the internal conductive ring 122 C-shaped and deformable radially, so that the internal conductive ring 122 could be elastically disposed in the ring containing space 129. A plurality of arc-shaped strips 136 could be formed on the internal conductive ring 122 in a radial arrangement and bends inwardly relative to the internal conductive ring 122. The amount of the strip and the curvature of each strip on the internal conductive ring 122 could be varied according to the practical application of the coaxial cable connector 104 and not limited to FIG. 6. Accordingly, the internal conductive ring 122 can have preferable radial elasticity to ensure that the internal conductive ring 122 can be surely in contact with the main body 128 and the metal foil layer 110 when the coaxial cable connector 104 jackets the coaxial cable 102.

To be noted, the structural designs of the external conductive ring and the internal conductive ring are not limited to the aforesaid embodiment. That is, all the ring contact designs of utilizing the external conductive ring to be in contact with the splitting sleeve of the metal sleeve and the metal braid layer of the coaxial cable and utilizing the internal conductive ring to be in contact with the main body of the metal sleeve and the metal foil layer of the coaxial cable may fall within the scope of the present invention. For example, in another embodiment, the plurality of arc-shaped strips could be formed on the external conductive ring in a radial arrangement and bends inwardly relative to the external conductive ring. As for the related description for other derived embodiments (e.g. the plurality of arc-shaped strips could be formed on the internal conductive ring in a radial arrangement and bends outwardly relative to the internal conductive ring, the external conductive ring could be a continuous ring structure to jacket the splitting sleeve and the metal braid layer in a ring-shaped surface contact manner, and so on), it could be reasoned by analogy according to the aforesaid embodiments and omitted herein.

Furthermore, the external conductive ring and the internal conductive ring could be alternatively omitted. For example, in another embodiment, the coaxial cable connector could only utilize the external conductive ring to jacket the splitting sleeve of the metal sleeve for establishing electrical connection between the metal sleeve and the metal braid layer when the splitting sleeve penetrates between the insulation layer and the metal braid layer of the coaxial cable (in this configuration, the coaxial cable could selectively have the metal foil layer formed thereon or not), or could only utilize the internal conductive ring to be disposed in the ring containing space of the metal sleeve for establishing electrical connection between the metal foil layer and the metal sleeve.

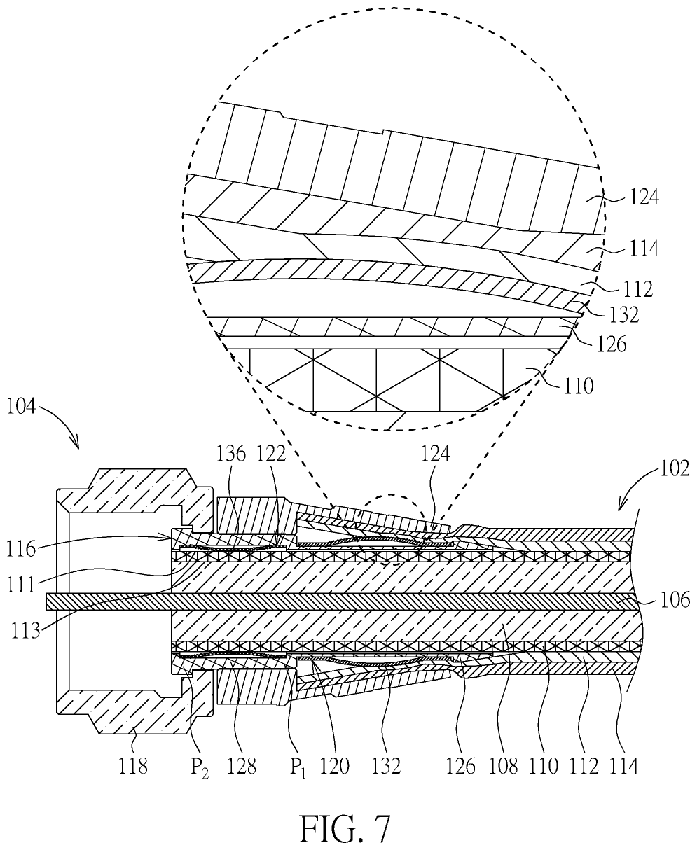

More detailed description for the connecting operation of the coaxial cable 102 and the coaxial cable connector 104 is provided as follows. Please refer to FIG. 3 and FIG. 7. FIG. 7 is a cross-sectional diagram of the coaxial cable 102 in FIG. 3 being fixed to the coaxial cable connector 104. When the coaxial cable 102 is inserted to a position as shown in FIG. 7 along an arrow A as shown in FIG. 3 relative to the coaxial cable connector 104, the splitting sleeve 126 penetrates between the metal foil layer 110 and the metal braid layer 112, so as to make the main body 128 jacket the metal foil layer 110 and make the metal braid layer 112 jacket the splitting sleeve 126. At the same time, the external conductive ring 120 jacketing the splitting sleeve 126 can utilize its radial elasticity to be surely in contact with the metal foil layer 112 and the splitting sleeve 126, so as to establish preferable and stable electrical connection between the metal braid layer 112 and the metal sleeve 116. In addition, the internal conductive ring 122 disposed in the main body 128 can utilize its radial elasticity to be surely in contact with the main body 128 and an external surface 111 (could be regarded as an external surface of the metal layer of the coaxial cable 102 in this embodiment) of the metal foil layer 110. Accordingly, the metal sleeve 116 can be in contact with the external surface 111 of the metal foil layer 110 via the internal conductive ring 122, but not in contact with an internal surface 113 (could be regarded as an internal surface of the metal layer of the coaxial cable 102 in this embodiment) of the metal foil layer 110. That is, the present invention adopts the design in which the metal sleeve 116 is not in contact with the internal surface of the metal layer of the coaxial cable 102 but in contact with the external surface of the metal layer of the coaxial cable 102 for simplifying the assembly process of the coaxial cable 102 and the coaxial cable connector 104 and establishing preferable and stable electrical connection between the metal sleeve 116 and the metal braid layer 110.

In practical application, since the coaxial cable 102 and the coaxial cable connector 104 are still in a loose engagement state, a fixing tool (e.g. a clamp) could be further utilized to squeeze the clamping sleeve 124 for causing radial deformation of the clamping sleeve 124, so that the clamping sleeve 124 can clamp the protection layer 114 tightly (as shown in FIG. 7) to fix the coaxial cable connector 104 to the coaxial cable 102 steadily.

Via the aforesaid electrical connecting design in which the external conductive ring abuts against the metal braid layer and the splitting sleeve via its elasticity and the internal conductive ring abuts against the main body and the metal foil layer via its elasticity, the present invention can establish preferable and stable electrical connection between the coaxial cable and the coaxial cable connector. In such a manner, the present invention can efficiently solve the prior art problem that embrittlement of the protection layer influences electrical connection between the coaxial cable connector and the metal braid layer of the coaxial cable, so as to improve the performance of the coaxial cable connector in EMI and RFI shielding, insertion loss and reflection loss. Thus, the present invention can greatly improve the signal transmission quality of the coaxial cable connector and efficiently solve the aforesaid cable aging problem.

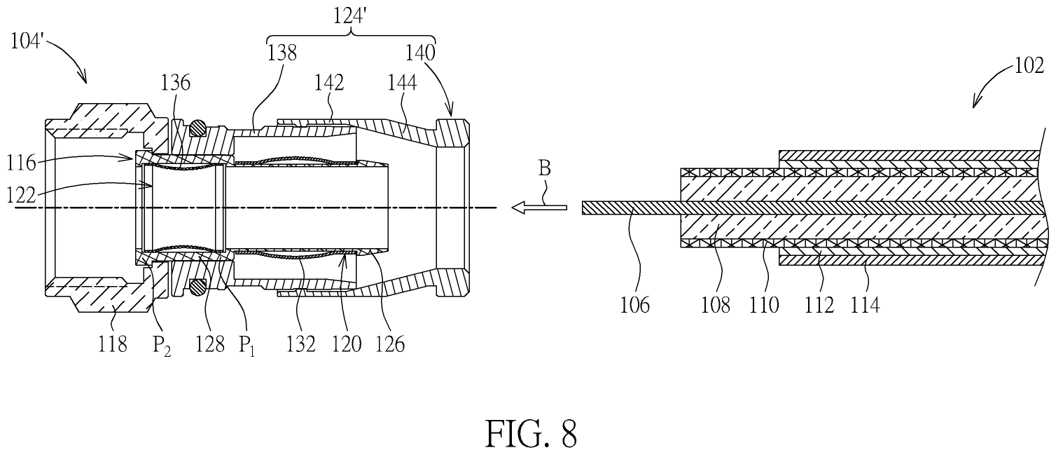

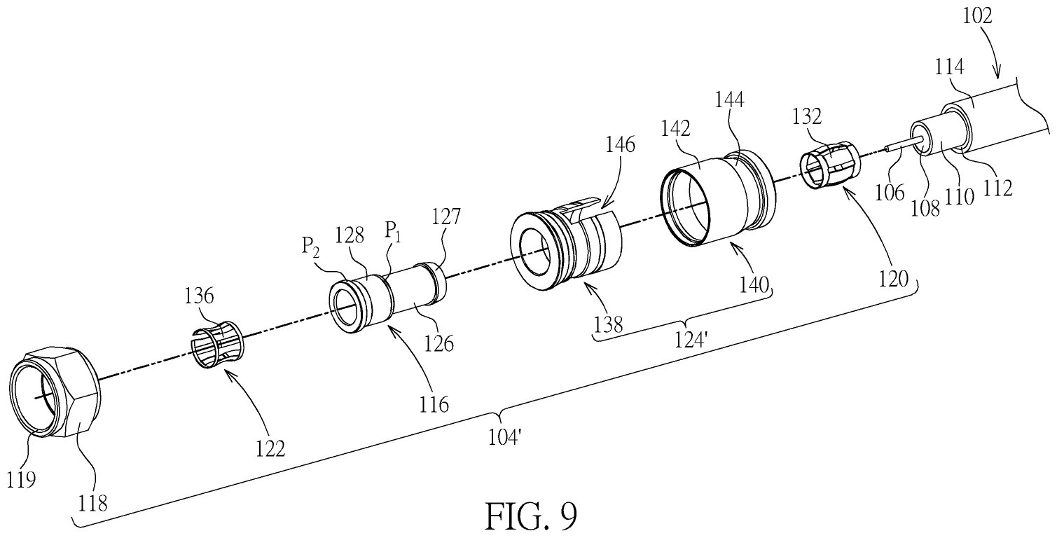

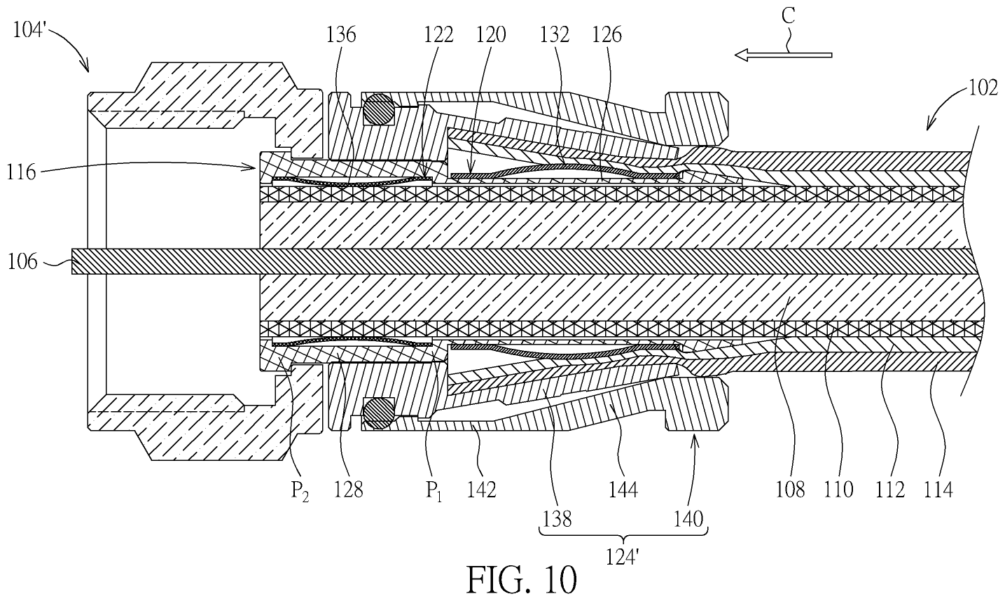

It should be mentioned that the structural design of the clamping sleeve is not limited to the one-piece sleeve design according to the aforesaid embodiment. That is, all the clamping sleeve designs for clamping the coaxial cable to fix the coaxial cable connector to the coaxial cable can be adopted by the present invention. For example, the present invention could adopt two-piece sleeve design. Please refer to FIG. 8, FIG. 9, and FIG. 10. FIG. 8 is an axial cross-sectional diagram of the coaxial cable 102 and a coaxial cable connector 104′ according to another embodiment of the present invention. FIG. 9 is an exploded diagram of the coaxial cable 102 and the coaxial cable connector 104′ in FIG. 8. FIG. 10 is a cross-sectional diagram of the coaxial cable 102 in FIG. 8 being fixed to the coaxial cable connector 104′. Components both mentioned in this embodiment and the aforesaid embodiments represent components with similar functions or structures, and the related description is omitted herein. As shown in FIG. 8, FIG. 9 and FIG. 10, the coaxial cable connector 104′ detachably jackets the coaxial cable 102 and includes the metal sleeve 116, the coupling sleeve 118, the external conductive ring 120, the internal conductive ring 122, and a clamping sleeve 124′. In this embodiment, the clamping sleeve 124′ could include an internal sleeve 138 and an external sleeve 140. The internal sleeve 138 jackets the first end portion P₁ of the main body 128. The external sleeve 140 could have a sleeve section 142 and a tapered section 144. An axial slot 146 could be formed on the internal sleeve 138 (but not limited thereto) such that radial deformation of the internal sleeve 138 may occur easily.

Via the aforesaid design, when the coaxial cable 102 is inserted to a position as shown in FIG. 10 along an arrow B as shown in FIG. 8 relative to the coaxial cable connector 104′, the splitting sleeve 126 penetrates between the metal foil layer 110 and the metal braid layer 112, so as to make the main body 128 jacket the metal foil layer 110 and make the metal braid layer 112 jacket the splitting sleeve 126. At the same time, the external conductive ring 120 jacketing the splitting sleeve 126 can utilize its radial elasticity to be surely in contact with the metal foil layer 112 and the splitting sleeve 126. In addition, the internal conductive ring 122 disposed in the main body 128 can utilize its radial elasticity to be surely in contact with the main body 128 and the metal foil layer 110.

In practical application, since the coaxial cable 102 and the coaxial cable connector 104′ are still in a loose engagement state, a fixing tool (e.g. a clamp) could be further utilized to push the external sleeve 140 toward the internal sleeve 138 along an arrow C as shown in FIG. 10, so as to make the sleeve section 142 jacket the internal sleeve 138. Subsequently, with pushing of the external sleeve 140 along the arrow C, the taped section 144 squeezes the internal sleeve 138 to cause radial deformation of the internal sleeve 138, so that the internal sleeve 138 can clamp the protection layer 114 tightly (as shown in FIG. 10) to fix the coaxial cable connector 104′ to the coaxial cable 102 steadily.

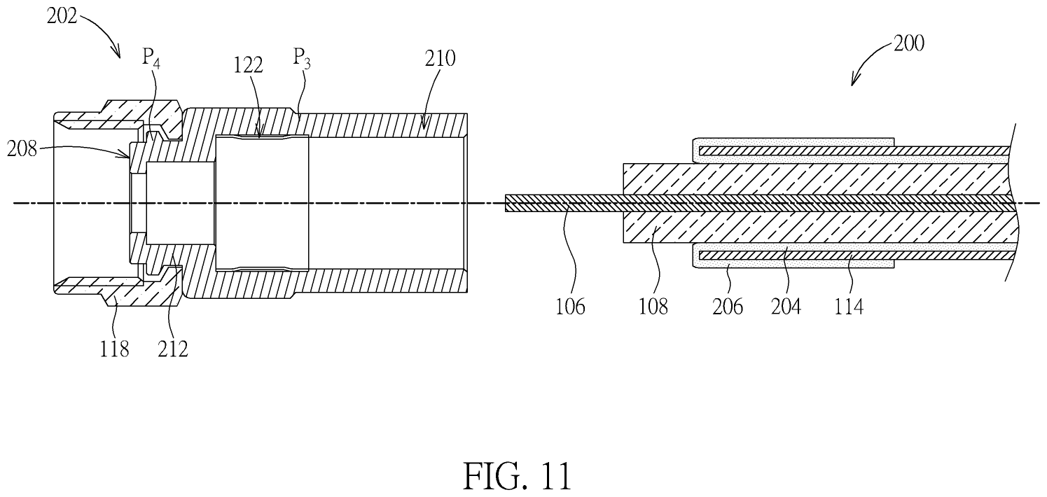

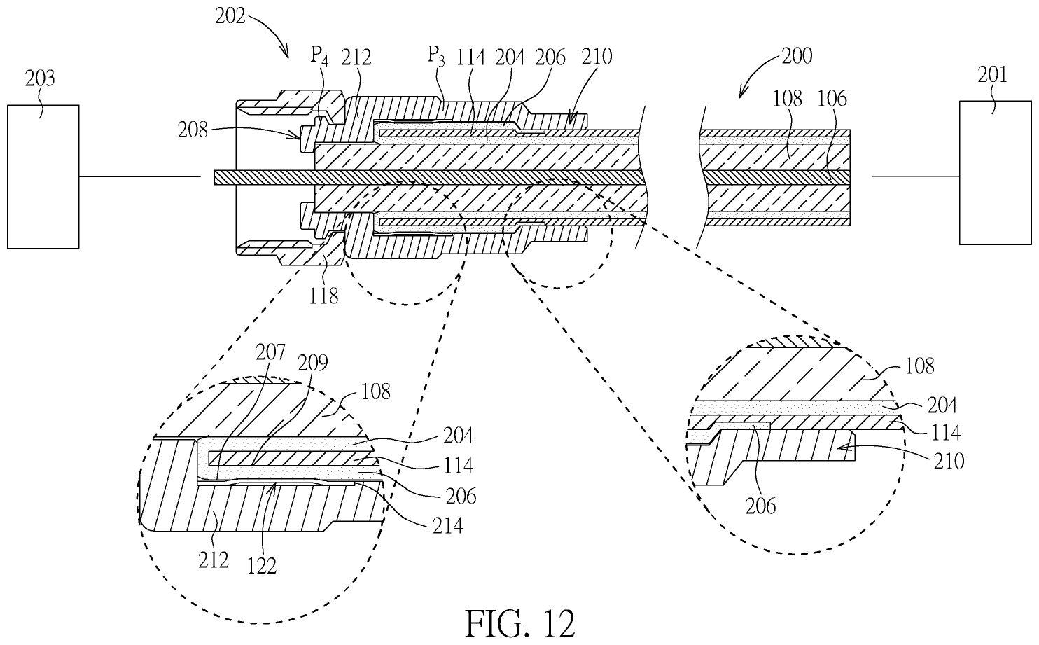

Furthermore, the contact design of the internal conductive ring and the coaxial cable is not limited to the aforesaid embodiments. For example, the present invention could adopt the design in which the internal conductive ring is directly in contact with the metal braid layer of the coaxial cable without the splitting sleeve. Please refer to FIG. 11 and FIG. 12. FIG. 11 is an axial cross-sectional diagram of a coaxial cable 200 and a coaxial cable connector 202 according to another embodiment of the present invention. FIG. 12 is a cross-sectional diagram of the coaxial cable 200 in FIG. 11 being fixed to the coaxial cable connector 202. Components both mentioned in this embodiment and the aforesaid embodiments represent components with similar functions or structures, and the related description is omitted herein. As shown in FIG. 11 and FIG. 12, the coaxial cable connector 202 is utilized to establish signal transmission between a front-end device and a back-end device (i.e. an electronic apparatus 201 and an electronic apparatus 203 as depicted by simplified lines in FIG. 12) after connecting to the coaxial cable 200. The aforesaid signal transmission generally refers to radio frequency signal transmission, and the electronic apparatus 201 and the electronic apparatus 203 could be preferably a device, an apparatus, or a connector for transmitting, receiving, or processing radio frequency signals, such as a distributor, a filter, or an amplifier for cable TV. The aforesaid connection between the coaxial cable 200 and the electronic apparatus 201 and connection between the coaxial cable connector 202 and the electronic apparatus 203 could be achieved in a direct connection manner or by other devices, apparatuses or connectors commonly seen in the prior art. Thus, the present invention does not limit the connection design of the coaxial cable 200 and the electronic apparatus 201 and the connection design of the coaxial cable connector 202 and the electronic apparatus 203.

The coaxial cable 200 includes the central conductor 106, the insulation layer 108, a first metal braid layer 204, a second metal braid layer 206, and the protection layer 114. In this embodiment, combination of the first metal braid layer 204, the second metal braid layer 206 and the protection layer 114 can be regarded as a metal layer of the coaxial cable 200 for providing EMI and RFI shielding when radio frequency signals are transmitted via the coaxial cable 200. The insulation layer 108, the first metal braid layer 204 and the protection layer 114 cover the central conductor 106 sequentially. The second metal braid 206 extends forwardly from the first metal braid layer 204 and is folded back relative to the protection layer 114, so that the protection layer 114 can be clamped between the first metal braid layer 204 and the second metal braid layer 206. As for the other related description for the layer design of the coaxial cable 200 (e.g. the layer material and the layer arrangement design of the coaxial cable 200), it is commonly seen in the prior art and omitted herein.

The coaxial cable connector 202 detachably jackets the coaxial cable 200 and includes a metal sleeve 208, a clamping sleeve 210, the coupling sleeve 118, and the internal conductive ring 122 (preferably formed by a sheet punching process, but not limited thereto). The metal sleeve 208 has a main body 212, and a ring containing space 214 is formed in the main body 212 for containing and axially limiting the internal conductive ring 122, so as to prevent detachment of the internal conductive ring 122. In this embodiment, the clamping sleeve 210 could preferably extend axially from a first end portion P₃ of the main body 212 by an integral-forming process (but not limited thereto, meaning that the present invention could adopt the two-piece sleeve design and the related description could be reasoned by analogy and omitted herein). The coupling sleeve 118 is disposed at a second end portion P₄ of the main body 212. As such, the coaxial cable connector 202 can be coupled to the electronic apparatus 203 capable of receiving coaxial cable signals, such as a digital TV set-top box or a cable modem, via the coupling sleeve 118.

Via the aforesaid design, when the coaxial cable 200 is inserted to a position as shown in FIG. 12 relative to the coaxial cable connector 202, the internal conductive ring 122 disposed in the main body 212 can utilize its radial elasticity to be surely in contact with the main body 212 and an external surface 207 (could be regarded as an external surface of the metal layer of the coaxial cable 200 in this embodiment) of the second metal braid layer 206. Accordingly, the metal sleeve 208 can be in contact with the external surface 207 of the second metal braid layer 206 via the internal conductive ring 122, but not in contact with an internal surface 209 (could be regarded as an internal surface of the metal layer of the coaxial cable 200 in this embodiment) of the second metal braid layer 206. That is, the present invention adopts the design in which the metal sleeve 208 is not in contact with the internal surface of the metal layer of the coaxial cable 102 but in contact with the external surface of the metal layer of the coaxial cable 200 for simplifying the assembly process of the coaxial cable 200 and the coaxial cable connector 202 and establishing preferable and stable electrical connection of the metal sleeve 208 to the first metal braid layer 204 and the second metal braid layer 206.

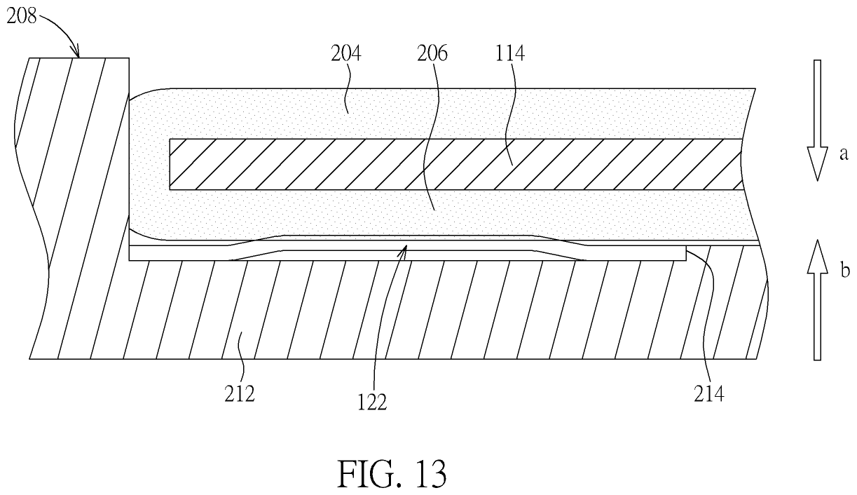

To be more specific, please refer to FIG. 13, which is a partial enlarged diagram of the metal sleeve 208 in FIG. 12. As shown in FIG. 13, the second metal braid layer 206 receives an elastic bias force a generated by the protection layer 114 and an elastic bias force b generated by the internal conductive ring 122 (the arrow direction in FIG. 13 represents the force exerting direction) to be clamped tightly between the protection layer 114 and the internal conductive ring 122. Since the internal conductive ring 122 and the main body 212 are electrically connected to each other, the metal sleeve 208 can be electrically connected to the second metal braid layer 206 and the first metal braid layer 204 of the coaxial cable 200 via the internal conductive ring 122.

When aging of the protection layer 144 occurs due to the environmental factor (e.g. temperature or moisture) and the time factor over a period of time to cause a decline of the elastic bias force a, the elastic bias force b generated by the internal conductive ring 122 can make compensation for the declined elastic bias pressure a. In such a manner, the coaxial cable connector 202 provided by the present invention not only establishes preferable and stable electrical connection of the metal sleeve 208 to the first metal braid layer 204 and the second metal braid layer 206 of the coaxial cable 200, but also provides a preferable EMI shielding environment and extends the service life of the coaxial cable 200.

In addition, since the coaxial cable 200 and the coaxial cable connector 202 are still in a loose engagement state, a fixing tool (e.g. a clamp) could be further utilized to squeeze the clamping sleeve 210 to cause radial deformation of the clamping sleeve 210, so that the clamping sleeve 210 can clamp the coaxial cable 200 tightly to fix the coaxial cable connector 202 to the coaxial cable 200 steadily. In practical application, the clamping sleeve 210 could be preferably squeezed at a position corresponding to the second metal braid layer 206 to cause radial deformation of the clamping sleeve 210. Accordingly, the clamping sleeve 210 can clamp the second metal braid layer 206 and the protection layer 144 (as shown in FIG. 12), so as to improve the torsional strength and the tensile strength between the coaxial cable 200 and the coaxial cable connector 202.

Via the aforesaid electrical connecting design in which the internal conductive ring directly abuts against the main body and the metal braid layer, the present invention can establish preferable and stable electrical connection between the coaxial cable and the coaxial cable connector. In such a manner, the present invention can efficiently solve the prior art problem that embrittlement of the protection layer influences electrical connection between the coaxial cable connector and the metal braid layer of the coaxial cable, so as to improve the performance of the coaxial cable connector in EMI and RFI shielding, insertion loss and reflection loss. Thus, the present invention can greatly improve the signal transmission quality of the coaxial cable connector and efficiently solve the aforesaid cable aging problem.

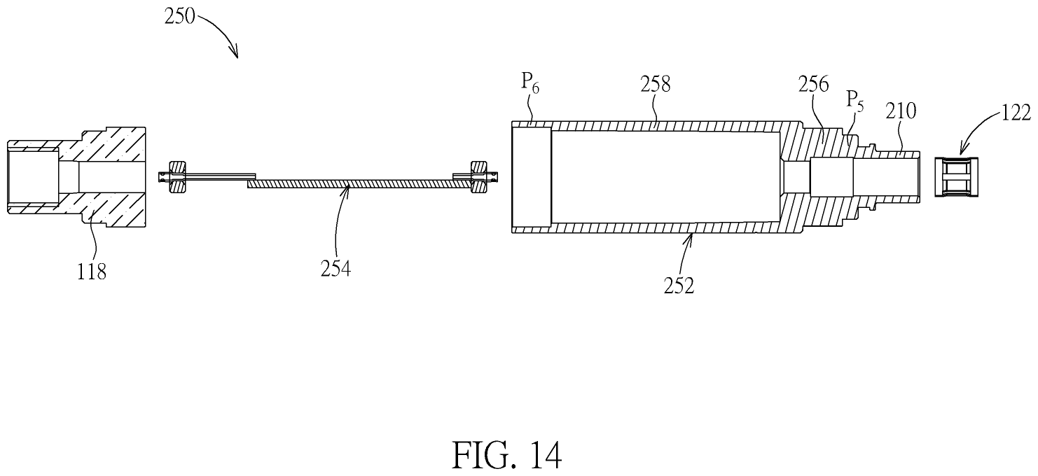

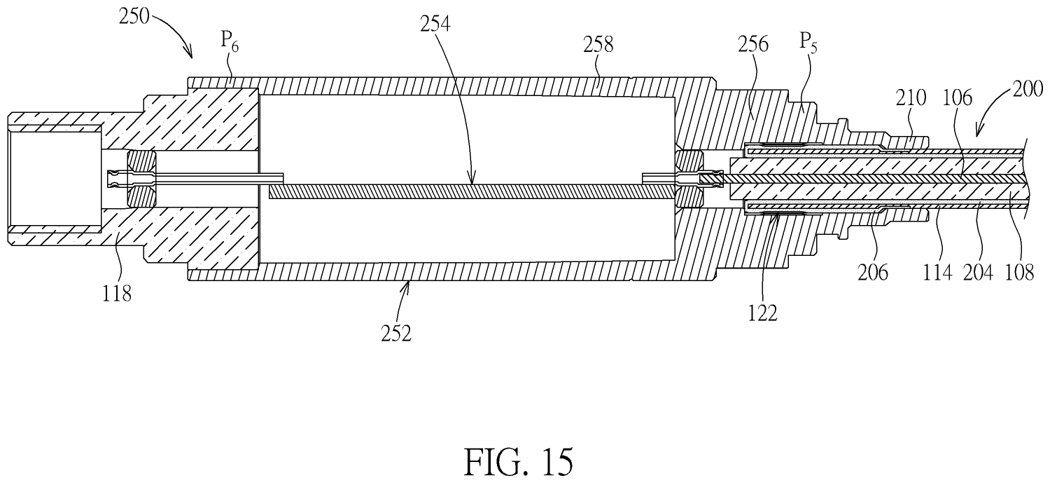

It should be mentioned that the connection design of the metal sleeve and the coupling sleeve is not limited to the aforesaid embodiments. Please refer to FIG. 14 and FIG. 15. FIG. 14 is an axial cross-sectional diagram of a coaxial cable connector 250 according to another embodiment of the present invention. FIG. 15 is a cross-sectional diagram of the coaxial cable connector 250 in FIG. 14 being fixed to the coaxial cable 200. Components both mentioned in this embodiment and the aforesaid embodiments represent components with similar functions or structures, and the related description is omitted herein. As shown in FIG. 14 and FIG. 15, the coaxial cable connector 250 includes a metal sleeve 252, a signal processing structure 254, the clamping sleeve 210, the coupling sleeve 118, and the internal conductive ring 122. The metal sleeve 252 has a main body 256 for containing the internal conductive ring 122. The clamping sleeve 210 could extend axially from a first end portion P₅ of the main body 256 in an integral-forming manner. A metal casing 258 extends from the main body 256 toward the coupling sleeve 118 to make a second end portion P₆ of the main body 256 connected to the coupling sleeve 118. As such, the coaxial cable connector 250 can be coupled to an electronic apparatus capable of receiving coaxial cable signals, such as a digital TV set-top box or a cable modem, via the coupling sleeve 118. The signal processing structure 254 is disposed in the metal casing 258 and is electrically connected to the coaxial cable 200 and the electronic apparatus respectively for establishing the signal transmission path between the coaxial cable 200 and the electronic apparatus. The signal processing structure 254 could be preferably a filter circuit, an amplifier circuit, a distributor circuit, an attenuator circuit, or any combination thereof for signal transmission and receiving. In this embodiment, the signal processing structure 254 could be formed on a conventional printed circuit board, but not limited thereto.

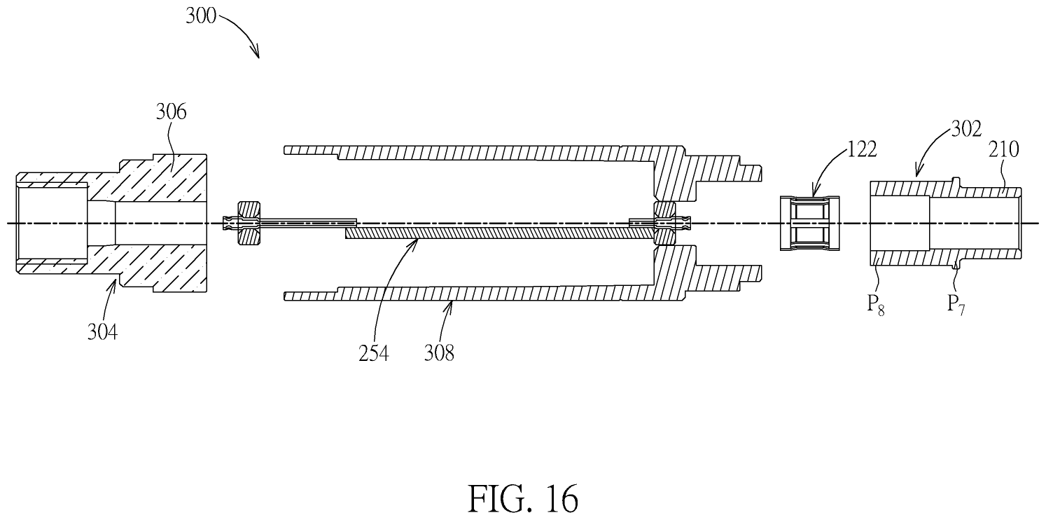

Moreover, the structural design of the metal sleeve is not limited to the one-piece sleeve design mentioned in the aforesaid embodiments. For example, the present invention could adopt the two-piece sleeve design. Please refer to FIG. 16, which is an axial cross-sectional diagram of a coaxial cable connector 300 according to another embodiment of the present invention. Components both mentioned in this embodiment and the aforesaid embodiments represent components with similar functions or structures, and the related description is omitted herein. As shown in FIG. 16, the coaxial cable connector 300 detachably jackets the coaxial cable 200 (not shown in FIG. 16) and includes a metal sleeve 302, a coupling sleeve 304, the signal processing structure 254, the clamping sleeve 210, and the internal conductive ring 122. The metal sleeve 302 is used for containing the internal conductive ring 122. The clamping sleeve 210 could extend axially from a first end portion P₇ of the metal sleeve 302 in an integral-forming manner (but not limited thereto, meaning that the present invention could adopt the two-piece sleeve design mentioned in the aforesaid embodiment, and the related description could be reasoned by analogy and omitted herein). In this embodiment, the coupling sleeve 304 includes a connector body 306 and a metal casing 308. The connector body 306 is detachably connected to an electronic apparatus capable of receiving coaxial cable signals, such as a digital TV set-top box or a cable modem. The metal casing 308 jackets the connector body 308 and a second end portion P₈ of the metal sleeve 302 respectively to form a two-piece detachable sleeve structure cooperatively with the metal sleeve 302 for convenience of subsequent assembly and maintenance processes.

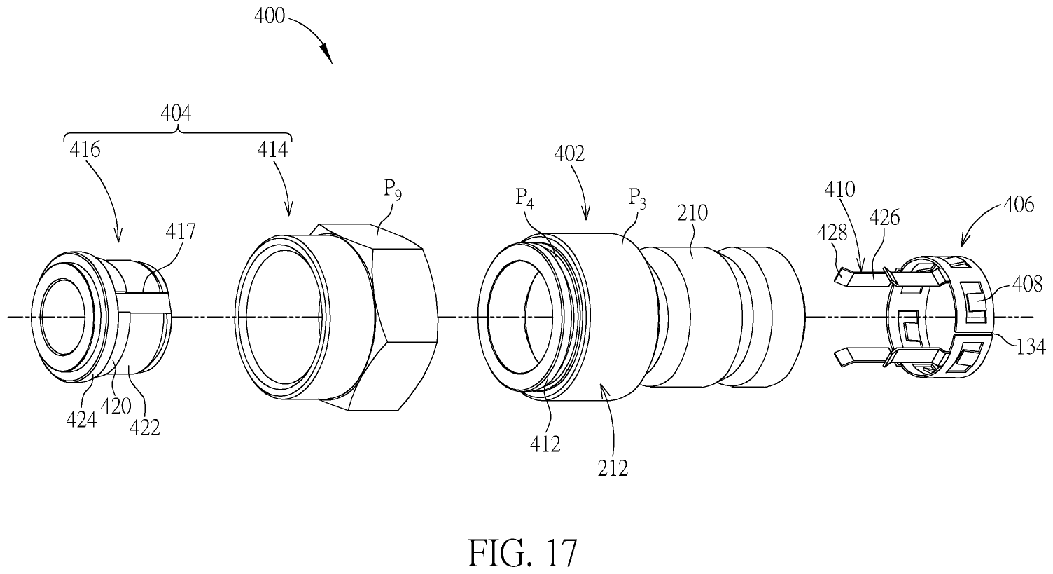

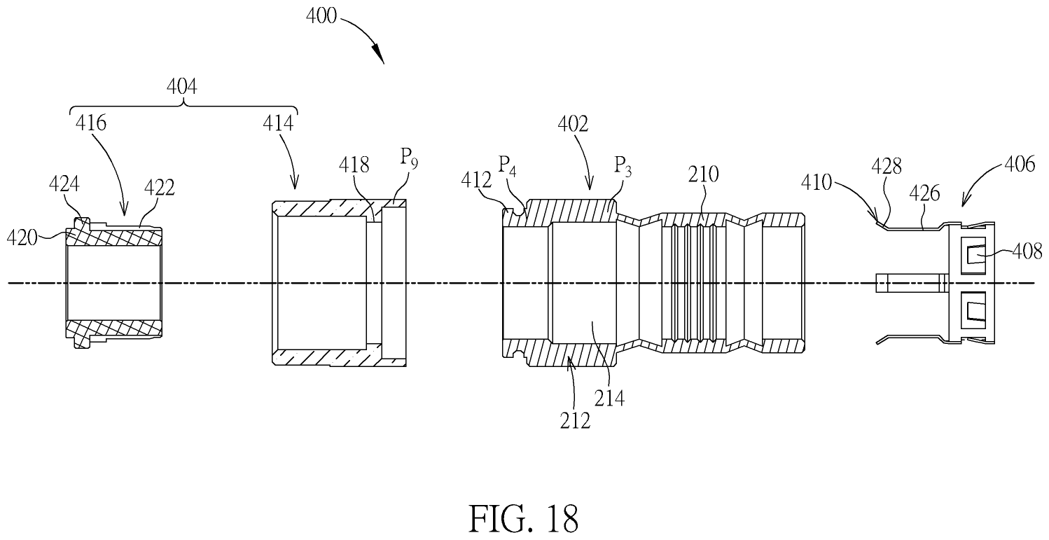

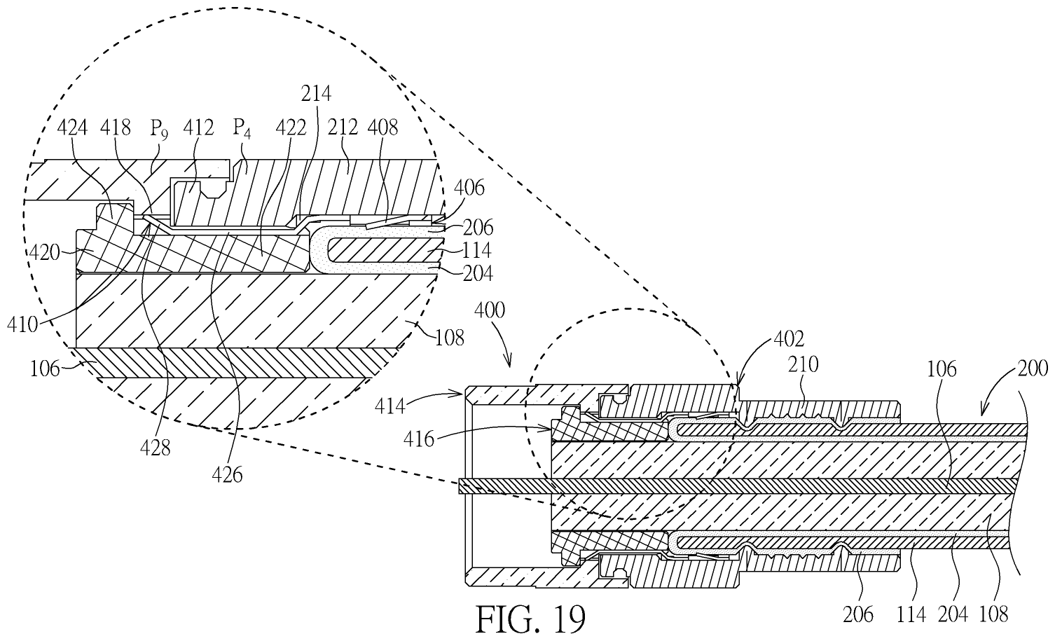

In practical application, for further improving the performance of the coaxial cable connector in EMI and RFI shielding, insertion loss, and reflection loss, the present invention could adopt the design in which the coaxial cable is electrically connected to the coupling sleeve via an internal conductive ring. For example, please refer to FIG. 17, FIG. 18, and FIG. 19. FIG. 17 is an exploded diagram of a coaxial cable connector 400 according to another embodiment of the present invention. FIG. 18 is an axial cross-sectional diagram of the coaxial cable connector 400 in FIG. 17. FIG. 19 is a cross-sectional diagram of the coaxial cable connector 400 in FIG. 18 being fixed to the coaxial cable 200. Components both mentioned in this embodiment and the aforesaid embodiments represent components with similar structures or functions. As shown in FIG. 17, FIG. 18, and FIG. 19, the coaxial cable connector 400 detachably jackets the coaxial cable 200. The coaxial cable connector 400 includes a metal sleeve 402, the clamping sleeve 210, a coupling sleeve 404, and an internal conductive ring 406. The metal sleeve 402 has the main body 212. The ring containing space 214 is formed in the main body 212 for containing and axially limiting the internal conductive ring 406 to prevent detachment of the internal conductive ring 406 from the main body 212.

Similarly, the cut-off slot 134 could be preferably formed on the internal conductive ring 406 (but not limited thereto) to make the internal conductive ring 406 C-shaped and deformable radially, and a plurality of tongue sheets 408 could be formed on the internal conductive ring 406 in a radial arrangement and bends inwardly (but not limited thereto, meaning that the present invention could adopt the design in which the tongue sheet bends outwardly or the arc-shaped strip design mentioned in the aforesaid embodiment) relative to the internal conductive ring 406. The amount of the tongue sheet on the internal conductive ring 406 could be varied according to the practical application of the coaxial cable connector 400 and not limited to FIG. 17. Accordingly, the internal conductive ring 406 can have preferable radial elasticity to ensure that the internal conductive ring 406 can be surely in contact with the main body 212 and the second metal braid layer 206 when the coaxial cable connector 400 jackets the coaxial cable 200.

Furthermore, at least one contact arm 410 (four shown in FIG. 17, but not limited thereto) extends from the internal conductive ring 406 toward the second end portion P₄ of the main body 212 to be in contact with the coupling sleeve 404 for establishing electrical connection between the coaxial cable 200 and the coupling sleeve 404 via the internal conductive ring 406. To be more specific, in this embodiment, a first limiting edge 412 protrudes from the second end portion P₄ of the main body 212 radially and outwardly, and the coupling sleeve 404 includes a connector body 414 and an internal limiting sleeve 416. The connector body 414 has a pivot end portion P₉. An internal edge 418 protrudes from the pivot end portion P₉ radially and inwardly. The internal limiting sleeve 416 has a limiting section 420 and a connection section 422. An axial slot 417 could be preferably formed on the internal limiting sleeve 416 (but not limited thereto) to make the internal limiting sleeve 416 deformable radially, such that the internal limiting sleeve 416 can be disposed through the connector body 414 and the main body 212 more smoothly. A second limiting edge 424 protrudes from the limiting section 420 radially and outwardly, and the connection section 422 extends from the limiting section 420 to be disposed through the second end portion P₄ for limiting the internal edge 418 between the first limiting edge 412 and the second limiting edge 424 (as shown in FIG. 19), so as to connect the connector body 414 to the second end portion P₄. The contact arm 410 has an extending arm portion 426 and a bending arm portion 428. The bending arm portion 428 bends from the extending arm portion 426 toward the internal edge 418. Accordingly, as shown in FIG. 19, when the internal conductive ring 406 is disposed in the ring containing space 214, the extending arm portion 426 is clamped between the connection section 422 and the main body 212, and the bending arm portion 428 is in contact with the internal edge 418.

In such a manner, the second metal braid layer 206 of the coaxial cable 200 can be electrically connected to the internal conductive ring 406 via the tongue sheet 412. In addition, via the stable electrical connection between the contact arm 410 of the internal conductive ring 406 and the internal edge 418 of the coupling sleeve 404, the second metal braid layer 206 of the coaxial cable 200 is electrically connected to the coupling sleeve 404 for providing a preferable and stable EMI shielding environment to the coaxial cable 200.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coaxial cable connector detachably jacketing a coaxial cable, the coaxial cable connector comprising:
a metal sleeve having a main body, a ring containing space being formed in the main body;
a clamping sleeve connected to a first end portion of the main body, the clamping sleeve being squeezed to deform radially to clamp the coaxial cable tightly;
a coupling sleeve disposed at a second end portion of the main body; and
an internal conductive ring disposed in the ring containing space;
wherein when the main body jackets the coaxial cable, the metal sleeve is in contact with an external surface of a metal layer of the coaxial cable via the internal conductive ring but not in contact with an internal surface of the metal layer, so as to establish electrical connection between the metal sleeve and the metal layer.

2. The coaxial cable connector of claim 1, wherein the clamping sleeve jackets the first end portion of the main body, the metal sleeve further has a splitting sleeve, the metal layer comprises a metal foil layer and a metal braid layer, and the splitting sleeve axially extends from the first end portion of the main body; the splitting sleeve penetrates between the metal foil layer and the metal braid layer when the coaxial cable connector jackets the coaxial cable, so as to make the main body jacket the metal foil layer and make the metal braid layer jacket the splitting sleeve; when the main body jackets the metal foil layer, the internal conductive ring is in contact with the main body and the metal foil layer to establish electrical connection between the metal sleeve and the metal foil layer.

3. The coaxial cable connector of claim 2 further comprises:
an external conductive ring jacketing the splitting sleeve, the external conductive ring being in contact with the splitting sleeve and the metal braid layer when the splitting sleeve penetrates between the metal foil layer and the metal braid layer, so as to establish electrical connection between the metal sleeve and the metal braid layer.

4. The coaxial cable connector of claim 1, wherein a plurality of tongue sheets is formed on the internal conductive ring in a radial arrangement and bends inwardly or outwardly relative to the internal conductive ring.

5. The coaxial cable connector of claim 1, wherein the clamping sleeve comprises an internal sleeve and an external sleeve, the internal sleeve jackets the first end portion of the main body and has an axial slot, the external sleeve has a sleeve section and a tapered section; when the sleeve section jackets the internal sleeve and the external sleeve moves axially toward the internal sleeve, the tapered section squeezes the internal sleeve to deform radially for clamping the coaxial cable tightly.

6. The coaxial cable connector of claim 1, wherein the metal layer comprises a protection layer, a first metal braid layer, and a second metal braid layer, the protection layer covers the first metal braid layer, and the second metal braid layer extends forwardly from the first metal braid layer and is folded back relative to the protection layer, so as to make the protection layer clamped between the first metal braid layer and the second metal braid layer; the internal conductive ring is in contact with the main body and the second metal braid layer when the main body jackets the coaxial cable, so as to establish electrical connection between the metal sleeve and the first and second metal braid layers.

7. The coaxial cable connector of claim 6, wherein the coupling sleeve is detachably connected to an electronic apparatus, a metal casing extends from the main body toward the coupling sleeve to make the second end portion connected to the coupling sleeve, and the coaxial cable connector further comprises:
a signal processing structure disposed in the metal casing and electrically connected to the coaxial cable and the electronic apparatus, for establishing a signal transmission path between the coaxial cable and the electronic apparatus.

8. The coaxial cable connector of claim 6, wherein the clamping sleeve is squeezed to deform radially at a position corresponding to the second metal braid layer, so as to make the clamping sleeve clamp the second metal braid layer and the protection layer tightly.

9. The coaxial cable connector of claim 6, wherein the coupling sleeve comprises a connector body and a metal casing, the connector body is detachably connected to the electronic apparatus, the metal casing jackets the second end portion of the main body and the connector body respectively, and the coaxial cable connector further comprises:
a signal processing structure disposed in the metal casing and electrically connected to the coaxial cable and the electronic apparatus respectively, for establishing a signal transmission path between the coaxial cable and the electronic apparatus.

10. The coaxial cable connector of claim 6, wherein at least one contact arm extends from the internal conductive ring toward the second end portion to be in contact with the coupling sleeve.

11. The coaxial cable connector of claim 10, wherein a first limiting edge protrudes from the second end portion of the main body radially and outwardly, the coupling sleeve comprises a connector body and an internal limiting sleeve, the connector body has a pivot end portion, an internal edge protrudes from the pivot end portion radially and inwardly, the internal limiting sleeve has a limiting section and a connection section, a second limiting edge protrudes from the limiting section radially and outwardly, and the connection section extends from the limiting section to be disposed through the second end portion for limiting the internal edge between the first limiting edge and the second limiting edge, so as to connect the connector body to the second end portion; the at least one contact arm has an extending arm portion and a bending arm portion, the bending arm portion bends from the extending arm portion toward the internal edge; when the internal conductive ring is disposed in the ring containing space, the extending arm portion is clamped between the connection section and the main body, and the bending arm portion is in contact with the internal edge.

12. The coaxial cable connector of claim 6, wherein the clamping sleeve extends axially from the first end portion of the main body in an integral-forming manner.

13. The coaxial cable connector of claim 1, wherein the clamping sleeve extends axially from the first end portion of the main body in an integral-forming manner.

14. A coaxial cable connector detachably jacketing a coaxial cable, the coaxial cable connector comprising:
a metal sleeve having a splitting sleeve and a main body, the splitting sleeve extending axially from a first end portion of the main body, the splitting sleeve penetrating between an insulation layer of the coaxial cable and a metal braid layer of the coaxial cable when the coaxial cable connector jackets the coaxial cable, so as to make the main body jacket the insulation layer and make the metal braid layer jacket the splitting sleeve;
a coupling sleeve disposed at a second end portion of the main body;
an external conductive ring jacketing the splitting sleeve, the external conductive ring being in contact with the splitting sleeve to establish electrical connection between the metal sleeve and the metal braid layer when the splitting sleeve penetrates between the insulation layer and the metal braid layer; and
a clamping sleeve jacketing the first end portion of the main body, the clamping sleeve being squeezed to deform radially to clamp the coaxial cable tightly.

15. The coaxial cable connector of claim 14, wherein the clamping sleeve comprises an internal sleeve and an external sleeve, the internal sleeve jackets the first end portion of the main body 128 and has an axial slot formed thereon, the external sleeve has a sleeve section and a tapered section; when the sleeve section jackets the internal sleeve and the external sleeve moves axially toward the internal sleeve, the tapered section squeezes the internal sleeve to deform radially for clamping the coaxial cable tightly.
